(19) United States
(12) Patent Application Publication
(10) Pub. No.: US 2015/0227138 A1
(43) Pub. Date: Aug. 13, 2015

(54) Method For Energy Demand Management In A Production Flow Line

(71) Applicant: Siemens Corporation, Orlando, FL (US)

(72) Inventors: Halil Ibrahim Gultekin, Highland Park, NJ (US); Dong Wei, Edison, NJ (US); Yan Lu, West Windsor, NJ (US); Mohsen A. Jafari, Princeton Junction, NJ (US)

(21) Appl. No.: 14/426,170

(22) PCT Filed: Aug. 23, 2013
(86) PCT No.: PCT/US2013/056404

§ 371 Date: Mar. 5, 2015

Related U.S. Application Data
(60) Provisional application No. 61/696,944, filed on Sep. 5, 2012.

(51) Int. Cl. G05B 19/418

(52) U.S. Cl. CPC G05B 19/41875; G05B 2219/39407

(57) ABSTRACT

A method for energy demand management in a production flow line having a plurality of stations. The method includes calculating a slack time for the production flow line or a selected station and determining an option of operation mode flexibility. In addition the method includes performing a feasibility analysis of the option and providing a solution based on an elasticity measure. The method is supported by a mean value analysis technique and discrete event simulation. The method provides an automated energy auditing and analysis tool in a production system.

### CROSS REFERENCE TO RELATED APPLICATION

This application claims the benefit under 35 U.S.C. §119(e) of U.S. Provisional Application No. 61/696,944 entitled CASE STUDY OF ENERGY DEMAND MANAGEMENT IN PRODUCTION LINES, filed on Sep. 5, 2012 which is incorporated herein by reference in its entirety and to which this application claims the benefit of priority.

### FIELD OF THE INVENTION

This invention relates to energy demand management, and more particularly, to a method for energy demand management in a production flow line having a plurality of stations wherein the method is supported by a mean value analysis technique and discrete event simulation.

### BACKGROUND OF THE INVENTION

Energy costs, including costs of electric power, have risen sharply in the recent past and are expected to continue to rise in the future. Those costs reflect increases in fuel and operating prices, as well as increased costs in the generation and transmission facilities. Many manufacturing facilities include a production operation that consumes a significant amount of the total energy used in the facility. Further, the production operation may include a plurality of stations whose performance varies from station to station. Energy use can vary dramatically on short and medium time frames in such facilities, resulting in additional demands on an electrical distribution system. Therefore, it is desirable to optimize energy usage in manufacturing facility so as to reduce costs and variability in energy demand.

### SUMMARY OF THE INVENTION

A method for energy demand management in a production flow line having a plurality of stations is disclosed. The method includes calculating a slack time for the production flow line or a selected station and determining an option of operation mode flexibility. In addition, the method includes performing a feasibility analysis of the option and providing a solution based on an elasticity measure.

### BRIEF DESCRIPTION OF THE DRAWINGS

FIG. 1A is a graph of velocity vs. time for a single stage production cycle.

FIG. 1B depicts a power consumption model for a single stage production cycle.

FIG. 2 depicts a decision tree for finding existing and potential sources of elasticity for energy demand management in a production flow line.

FIG. 3 depicts a generic serial production flow line.

FIG. 4 includes Table 1 which depicts case study results of a computer simulation for an automotive paint shop line.

FIG. 5 includes Table 2 which depicts case study results of the computer simulation for a generic serial production flow line.

FIG. 6 includes Table 3 which depicts decision tree paths and nodes visited related to the case studies of Tables 1 and 2.

FIG. 7 is a block diagram of a computer system in which embodiments of the invention may be implemented.

### DESCRIPTION OF THE INVENTION

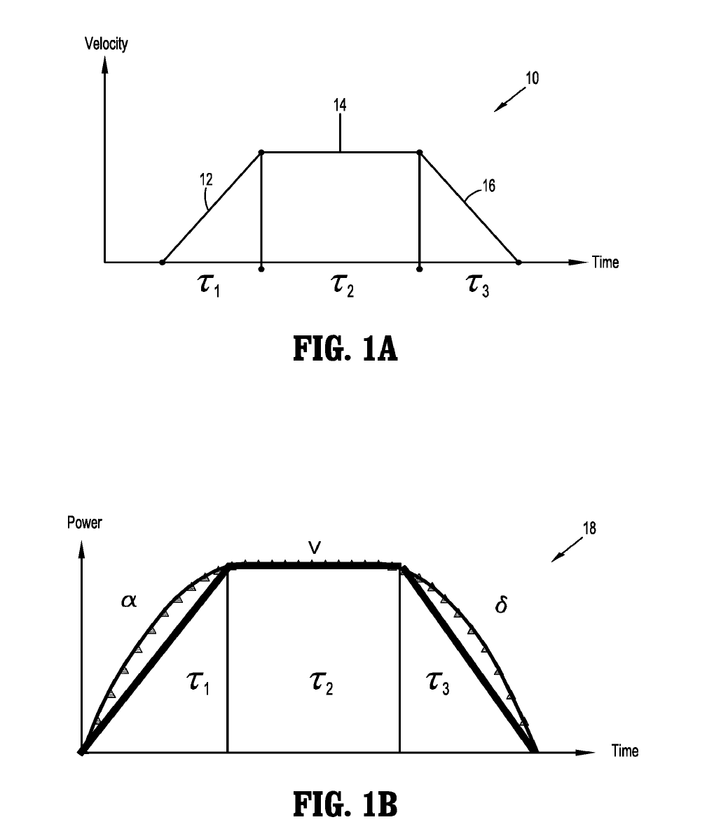

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings. In the description below, like reference numerals and labels are used to describe the same, similar or corresponding parts in the several views of FIGS. 1-7.

A production flow line may include a plurality of stations (i.e. “multi-station production flow line) whose performance varies from station to station. One type of multi-station production flow line is a paint shop in an automotive manufacturing plant. In particular, it has been found that paint shops use up to approximately 60% of the overall energy in an automotive manufacturing plant. It is understood that the current invention is also applicable to other types of multi-station production flow lines.

In an aspect of the invention, a method is disclosed for finding existing and potential sources of elasticity for energy demand management in a production flow line. In an embodiment, a mean value analysis technique is used in conjunction with discrete event simulation to support a calculation engine for a decision tree. Three types of elasticity are considered in the analysis. A first type of elasticity is Elasticity to Demand Response (i.e. “EDR”) which is defined as how effective a production system is able to respond to demand response (i.e. “DR”) signals from an electric power grid. A second type of elasticity is Elasticity to Load Shift (i.e. “ELS”) which is defined as how effective the production system is able to shift its load from peak periods to non-peak periods. A third type of elasticity is Elasticity to Energy Efficiency (i.e. “EEE”) which is defined as to what extent the production system is able to reduce its overall energy consumption.

It has been found that the EDR and ELS measures are positively correlated, so that a production system with high elasticity to DR is substantially elastic to load shifts, or vice versa. EDR, however, is affected by an external factor, namely, the timing of the DR signal from an electric power utility. As such, the analysis is based solely on ELS and EEE elasticity measures. Further, it is noted that a higher EEE facilitates effective solutions to demand response and load shifting.

The elasticity measures used herein take into account production system invariants and the economic and technical feasibility of design changes. The elasticity measures are defined in terms of system slack times and operation mode flexibility. Operation mode flexibility refers to changes in production schedules, change of machine speed or machine cycles and the use of buffer storage between stations. For example, once a machine at a station finishes work on a product, the product may be stored in a buffer storage location. The machine can then be placed in another mode of operation until the machine is needed again. One mode of operation that may be used is a sleep mode wherein the amount of energy used by the machine is reduced.

Further, the analysis is based on the use of two production invariants. These are the time interval (i.e. “T”) during which a number of units (i.e. “P”) must be completed and released from the production line. Within T, the time for maintenance, breaks and any additional miscellaneous activity times required for production is included. Any left over time after these tasks are completed is considered slack time. In addition, product quality, which may be considered to be an implicit variant, is assumed to be unchanged under all alternatives. It is further assumed that the invariant quantities are optimal with respect to performance and quality of products and that the invariant quantities are not be affected by the introduction of new energy demand management measures.

If a production system already has significant amounts of existing, or positive slack times, and scheduling flexibility is allowed within the constraints of production invariants, the system is then elastic to both energy efficiency and load shifts. In the absence of existing slack times, it may be possible to speed up some, or all, stations that are impeding production (i.e. that are creating bottlenecks in production) and/or introduce buffer storage for works in progress (i.e. “WIP”) in order to create slack time. In such cases, the production system has potential elasticity to both load shifts and energy efficiency. Potential elasticity also exists if machine cycle times can be optimized with respect to energy without changing the production invariants.

### Methodology

In accordance with the invention, a mean value analysis technique is described that is supported by discrete event simulation to compute energy consumption, such as electric power consumption, in production flow lines. The current invention also provides a decision tree structure which uses the mean value analysis technique to determine existing and/or potential sources of ELS and EEE.

### Power Consumption Calculation

The power consumption of individual stations in a production flow line, along with the power consumption of the entire production flow line, are both modeled. The methodology also includes power metering requirements and the means to collect data. The models use a mean value analysis technique that focuses on average measures and ignores variance of the underlying processes. When variability in station cycle times is low, the mean value analysis is expected to yield reasonably accurate results. Any deviation between estimates and true values widens as variance of station cycles, idle and other stoppage times widens. In addition, simulation will provide more accurate results when process variability is significantly high. In the following description, E( ) and Var( ) are used to represent mean and variance operators.

### Single Station Model

Single-cycle stage (i.e. “single stage”) and multi-cycle stage (i.e.“multi-stage”) production stations are considered in the current invention. A production cycle is defined per part or work piece. A single stage production cycle includes a ramp up (acceleration) period, a constant velocity period and a ramp down period (deceleration). A multi-stage production cycle includes a plurality of ramp up, constant velocity and ramp down periods. More power is consumed during ramp up and ramp down periods than in a constant velocity period. Thus, a multi-stage production cycle consumes more power as compared to a single-stage production cycle having the same overall duration. Therefore, reducing the number of cycles or running the production stage with different ramp up or ramp down functions significantly changes power consumption.

Referring to FIG. 1A, a graph 10 of velocity vs. time of a single stage production cycle is shown. Velocity refers to the velocity of any process and can be measured in terms of discrete units/time unit, or revolution per minute (rpm). The graph 10 includes a ramp-up portion 12, a constant velocity portion 14 and a ramp-down portion 16 which occur during first, second and third time periods denoted as τ₁, τ₂ and τ₃, respectively. Each time period τ₁, τ₂, τ₃ is further defined by a rate of change in velocity (e.g., production rate) and duration. Functional forms are used to describe these changes.

FIG. 1B shows a graph 18 of power vs. time and depicts a power consumption model for a single stage production cycle. Power consumption is parametrically defined on the basis of acceleration rate (α), constant velocity (ν) and deceleration rate (δ). It is noted that the graph 18 shown in FIG. 1B may differ depending on the energy profile of an individual station. In particular, FIG. 1B depicts power consumption of a typical direct current (i.e. “DC”) motor.

Multi-stage production cycles are characterized by a sequence of multiple single cycles (a single stage production cycle as depicted in FIG. 1A) separated by non-active times. An example of this arrangement is in robotic applications wherein a robot carries out a sequence of moves (loads and unloads) and operations (e.g. painting), with inactive periods in between. The total power consumption is the addition of all the terms over different cycles.

The following state variables are defined:

$${S}_{i} = \{ \begin{matrix}- 1 & if station i is at setup stage or waiting to be loaded or unloaded \\ 0 & if station i is not working on a part \\ 1 & if station i is working on a part\end{matrix}$$

X=(θ; ω; η; β; P; T) where
θ=(θ₁; θ₂, . . . θₙ) and θᵢ is random duration of a visit to state 1;
ω=(ω₁; ω₂ . . . ωₙ) and ωᵢ is random duration of a visit to state 0;
η=(η₁; η₂; . . . ηₙ) and ηᵢ is random duration of a visit to state −1;
and
β=(β₁; β₂; . . . βₙ₋₁) where βⱼ is the storage capacity of buffer j measured in number of workpieces. βⱼ can also be defined in delay time units.

### Measurability and Data Availability Criteria

Manufacturing line databases typically include station cycle time data (θᵢ) but detail data on ramp up and ramp down rates may not be readily available, especially with older machine control technology. In many automated applications, θ is fixed with respect to a single product type, but for a large number of mixed products, it can be reasonably considered random. Direct observation of ηᵢ and ωᵢ may not be so common in manufacturing systems. In such cases, θᵢ, ωᵢ and ηᵢ may be represented by a single variable Θᵢ and statistical estimates may be used that utilize aggregated samples of observed values on time between two successive station of production cycles. In the current invention, it will be assumed that metering data is available. The issues of measurability and data availability will be further described.

Given that θᵢ's, α, δ, τ₁, τ₂, τ₃ are measurable, a sample of a single production cycle may be written as:

θᵢ≅{(α,τ₁);(ν;τ₂);(δ,τ₃)} (1)

For multi-cycle production stages, a sample from θᵢ distribution is converted to the following set of pairs:

θᵢ≅{(α^{k},τ₁^{k});(ν^{k};τ₂^{k});(δ^{k},τ₃^{k});idleₖ|1≦k≦# of cycles} (2)

Given the above pairs and using the function of FIG. 1B one can compute the power consumption of station over a sampled value of θᵢ. Power consumption is assumed to be linearly dependent on a change in velocity and is approximated as shown in FIG. 1B. Further, two motor constants are associated with the motor. These are a constant for acceleration (i.e. “K1 constant”) and a constant for deceleration (i.e. “K2 constant”). This assumption is true for DC motors but is nearly an approximation for other motors such as AC servo motors.

πᵢ(θᵢ)=└|K1|*(α*τ₁²)/2+(ν*τ₁)/2┘+ν*τ₂+└|K2|*(|δ|*τ₃²) (3)

For random θᵢ, πᵢ(θᵢ) will be a random variable; in that case, πᵢ( θ̅ᵢ) will be average value over a sample space of θᵢ's, and will be approximated by πᵢ(E(θᵢ)). We will assume constant power usage rates over sampled ωᵢ and ηᵢ. We will, respectively, denote by πᵢ(ωᵢ) and ζᵢ( η̅ᵢ) the average power usage when Sᵢ is 0 or −1, where ω̅ᵢ and η̅ᵢ are the respective average duration of states 0 and −1.

Given T and P invariants, we have:

E(θᵢ)≦T/P∀ i=1, . . . ,n (4)
Let γᵢ be a random variable defined as the theoretical number of (θᵢ+ωᵢ+ηᵢ), i=1, . . . , n, that can possibly fall within T.

We then have:
γ_{b}=P for bottleneck station(s) b and

for non bottleneck station i, γᵢ=γ_{b}+εᵢ (5)
where εᵢ≧0 is a random variable with mean and variance dependent on θᵢ distribution, storage capacities, etc.

Let Tᵢ be the total time required by station i to fulfill its production requirements for time period T. Then we have:

Slack_time( )≦T−Tᵢ

E(Tᵢ)≧γ_{b}×( θ̅ᵢ+ ω̅ᵢ+ η̅ᵢ)

and

πᵢ( T̅ᵢ)≧γ_{b}×(πᵢ( θ̅ᵢ)+πᵢ( ω̅ᵢ)+πᵢ( η̅ᵢ)) (6)

Equation (6) assumes that ηᵢ and ωᵢ are observable and corresponding data is available. In cases where data is available only on Θᵢ we will instead use equation (6′) as shown below:

E(Tᵢ)γ_{b}×( Θ̅ᵢ)

and

πᵢ( T̅ᵢ)≧γ_{b}×(πᵢ( Θ̅ᵢ) (6′)

Strict equality in equation (6) or equation (6′) will hold if station i stops working after it fulfills its production requirements to meet P and T invariants and there is no power consumption during its slack time.

In some manufacturing operations, a WIP may be allowed from one production period (i.e., T) to another. In such cases, station i will run γᵢ cycles and the power consumption will be approximately given by:

πᵢ( T̅ᵢ)≈(γ_{b}+E(εᵢ)×(πᵢ( θ̅ᵢ)+πᵢ( ω̅ᵢ)+π( η̅i))

or

πᵢ( T̅ᵢ)≈(γ_{b}+E(εᵢ))×(πᵢ( Θ̅ᵢ))

and

Slack_timeᵢ=T−Tᵢ−E(εᵢ)×E(Θᵢ) (7)

If power is still used by station i in its slack times, then the expected power consumption will have additional term πᵢ( s̅l̅a̅c̅k̅_̅t̅i̅m̅e̅). We will assume constant power usage rate over a sampled slack_time of station i.

### Production Flow Line

The total power consumption for the line can be derived from the power consumption of the individual stations. We approximately have:

$${Π}_{line} ( P , T ) = {\sum }_{i = 1}^{n} {π}_{i} ( {\overline{T}}_{i} ) + {π}_{i} ( \overline{{Slack\_time}_{i}} ) \qquad ( 8 )$$

We introduce two new measurable variables for the production line, namely,

M=stoppage due to maintenance and B=stoppage due to breaks.

Assuming that the line stops when it fulfills its requirements for P and T, we have:

Slack_{—}timeₒᵥₑᵣₐₗₗ( )=T−γ_{b}×( θ̅_{b}+ ω̅_{b}+ η̅_{b})− M̅− B̅

or

Slack_timeₒᵥₑᵣₐₗₗ( )=T−γ_{b}×( θ̅_{b}+ ω̅_{b}+ η̅_{b})− M̅− B̅ (9)

### Decision Tree

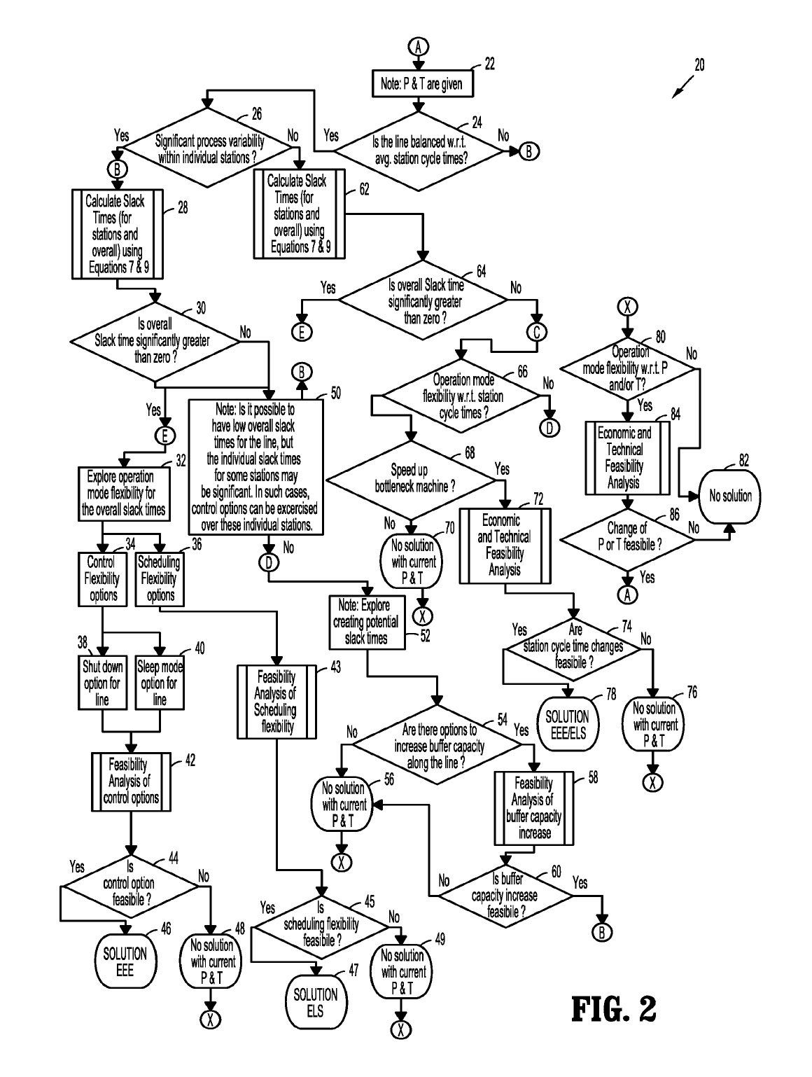

Referring to FIG. 2, a decision tree 20 is shown which provides a method for finding existing and potential sources of elasticity for energy demand management in a production flow line. The decision tree 20 includes decision nodes, analysis nodes, terminal action nodes and decision paths. The decision nodes are structured around slack times and operation mode flexibility as previously described. Any solution strategy that is generated through use of the decision tree 20 is evaluated to determine whether the solution strategy is economically and technologically feasible in an analysis node. Feasibility is achieved if the net present value (i.e. “NPV”) of savings from EEE and/or ELF measured over a planning horizon exceeds the investment costs. The economic and technological feasibility may be determined by using conventional techniques. A terminal node is achieved when a solution is available or no feasible solution exists, in which case, EEE and ELS measures are considered relatively insignificant. Terminal nodes are labeled with EEE and/or ELS depending on the application scope of the solution.

The analysis is based on the use of production invariants T and P as previously described and are considered given at node 22 of branch A. Next, a determination is made as to whether the production line is balanced with respect to (indicated as “w.r.t.” in FIG. 2) average station cycle times at node 24. If the production line is not balanced with respect to average station cycle times, the decision tree proceeds to branch B as will be described. If the production is considered balanced, a determination is made at node 26 as to whether significant process variability exists between individual stations in a multi-station production line. If significant process variability exists, the decision tree proceeds to branch B and a slack time is calculated for each station and for the overall production line using equations (7) and (9) at node 28. If the overall slack time is determined to be significantly greater than zero at node 30, the decision tree 20 proceeds to branch E wherein an operation mode flexibility option for the overall slack time is investigated at node 32. The operation mode flexibility options include control flexibility options at node 34 and scheduling flexibility options at node 36. The control flexibility options include a shutdown option for the line at node 38 or a sleep mode option for the line at node 40. A feasibility analysis of the control options is then conducted at node 42. A determination is then made at node 44 as to whether a control option is feasible. If the control option is feasible, then an EEE solution is achieved at node 46. If the control option is not feasible, then no solution is available when using the current P and T at node 48. Returning back to node 36, a feasibility analysis of scheduling flexibility is then conducted at node 43. A determination is then made at node 45 as to whether scheduling flexibility is feasible. If the scheduling flexibility is feasible, then an ELS solution is achieved at node 47. If scheduling flexibility is not feasible, then no solution is available when using the current P and T at node 49.

Returning back to node 30, if the overall slack time is determined to not be significantly greater than zero, it is noted at node 50 that it is possible for the line to have a low overall slack time but that individual slack times for some stations that may be significant. In such cases, control options may be used for the individual stations and the decision tree proceeds to branch B. If the individual slack times are not significant, the decision tree proceeds to branch D wherein the creation of potential slack times is investigated at node 52. A determination is then made at node 54 as to whether there are options for increasing buffer capacity. If no options for increasing buffer capacity are available, then no solution is available when using the current P and T at node 56. If options for increasing buffer capacity are available, a feasibility analysis of the buffer capacity increase is conducted at node 58. A determination is then made at node 60 as to whether the buffer capacity increase is feasible. If the buffer capacity increase is not feasible, then no solution is available when using the current P and T at node 56. If the buffer capacity increase is feasible, then the tree proceeds to previously described branch B.

Returning back to node 26, if significant process variability does not exist, a slack time is calculated for each station and for the overall production line using equations (7) and (9) at node 62. If the overall slack time is determined to be significantly greater than zero at node 64, the decision tree proceeds to previously described branch E. If the overall slack time is determined to not be significantly greater than zero, the decision tree proceeds to branch C wherein a determination is made at node 66 as to whether operation mode flexibility with respect to station cycle times exist. If no operation mode flexibility exists, the decision tree proceeds to previously described branch D. If operation mode flexibility exists, a determination is made at node 68 as to whether a speed of at least one machine causing a bottleneck can be increased. If the speed of at least one machine causing a bottleneck cannot be increased, then no solution is available when using the current P and T at node 70. If the speed of at least one machine causing a bottleneck can be increased, an economic and feasibility analysis is conducted at node 72. A determination is then made at node 74 as to whether any station cycle time changes are feasible. If station cycle time changes are not feasible, then no solution is available when using the current P and T at node 76. If the station cycle time changes are feasible, then an EEE/ELS solution is achieved at node 78.

When no solution is available when using the current P and T such as at nodes 48, 49, 56, 70 and 76 as previously described, the decision tree proceeds to branch X wherein a determination is made at node 80 as to whether operation mode flexibility exists with respect to P and/or T. If operation mode flexibility does not exist, then no solution exists at node 82. If operation mode flexibility exists, an economic and feasibility analysis is conducted at node 84. If a change in P or T is feasible at node 86, the decision tree proceeds to previously described branch A. If a change in P or T is not feasible, then no solution exists at node 82.

Therefore, the decision tree starts with an overall look at a production line and determines if slack times exist. For balanced production lines where average performances of individual stations are close and process variability is low, all stations act nearly as a bottleneck. In this case, station level slack times are negligible and an overall slack time exists only if the right side of equation (9) is significantly greater than zero. In the presence of operation mode flexibility, and by shortening station cycle times for all stations, additional slack times may be generated. If such a solution is not feasible, and neither P nor T can be changed, then EEE and ELS measures are relatively insignificant and the decision path ends with no solution. A solution is reached when economic and technological feasibility of operation mode flexibility leads to exploiting slack times for individual stations or for the overall production line. If slack times exist or can be created by operational mode changes, then the line is said to have positive ELS and EEE measures.

For unbalanced production flow lines, slack times at station levels and the slack time for the overall production line are investigated. In such production lines, there are usually one or more bottlenecks whereas the remaining stations work faster, resulting in positive slack times. If significant station and/or overall slack times exist, the decision path leads to analyzing the economic and technological feasibility of operation mode flexibility. For instance, placing one or more stations into sleep mode during their slack times may significantly reduce the power consumption. Additional slack times (for stations and overall production line) can be generated by adding buffer storage capacity between fast and bottleneck stations. This will reduce the non-productive times of stations (i.e. Sᵢ=0). The effect of buffer storage increases when there is a degree of process variability in some or all of the stations.

Operation mode flexibility can be determined in number of ways. For example, power consumption may be reduced by changing the ramp up and ramp down periods and/or rates as well as changing the number of cycles in a multi-cycle station. The use of sleep modes while a station is at states (Sᵢ=0 or −1) or during its slack times may result in significant reductions in power consumption and impact EEE measures of the production line. In the presence of positive slack times and with production schedule flexibility, a significant increase in ELS measures may be achieved.

### Illustrative Example

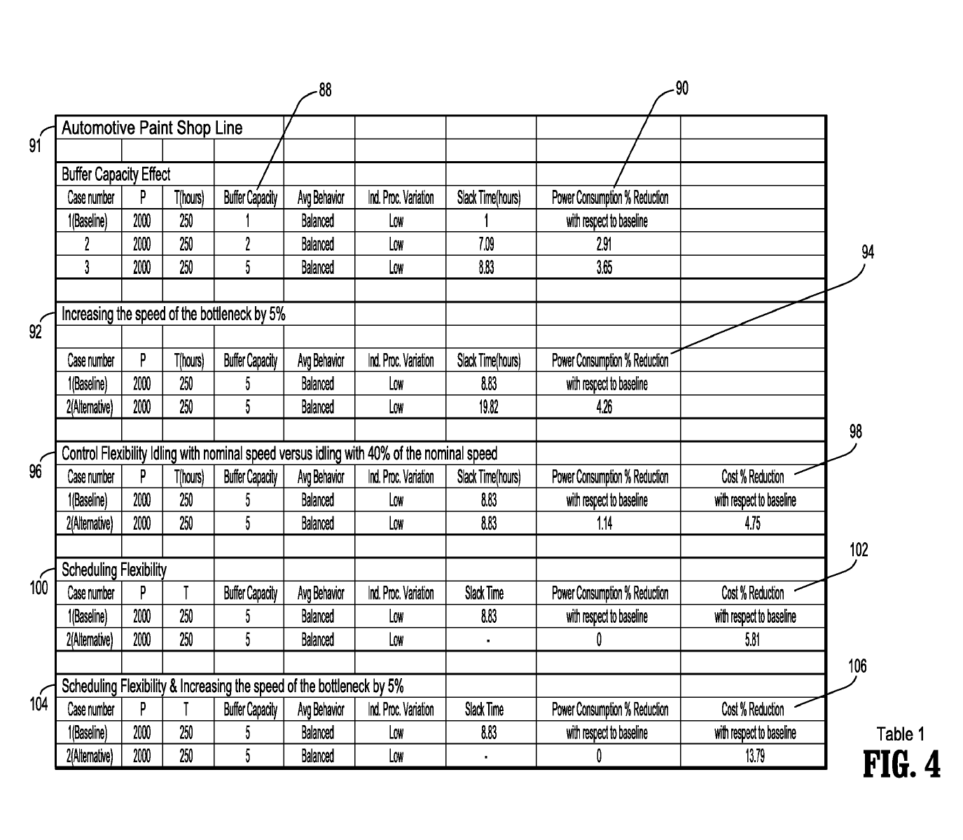

The current invention will now be described in connection with two case studies. The first case study is for a computer simulation of a flow line configuration having nine stations such as that found in a solvent based automotive paint shop. The nine stations represent the following operations in sequence: Phosphate Booth; Electro-Coat Booth; Electro-Coat Oven; Sealer Booth; Sealer Oven; Prime Booth; Prime Oven; Base-Coat Clear Coat Booth; and Base-Coat Clear Coat Oven. Such configurations typically have small process variability with respect to the stations and small buffer storage capacities. Results of a computer simulation for an automotive paint shop line 91 in accordance with the invention are shown in Table 1 of FIG. 4.

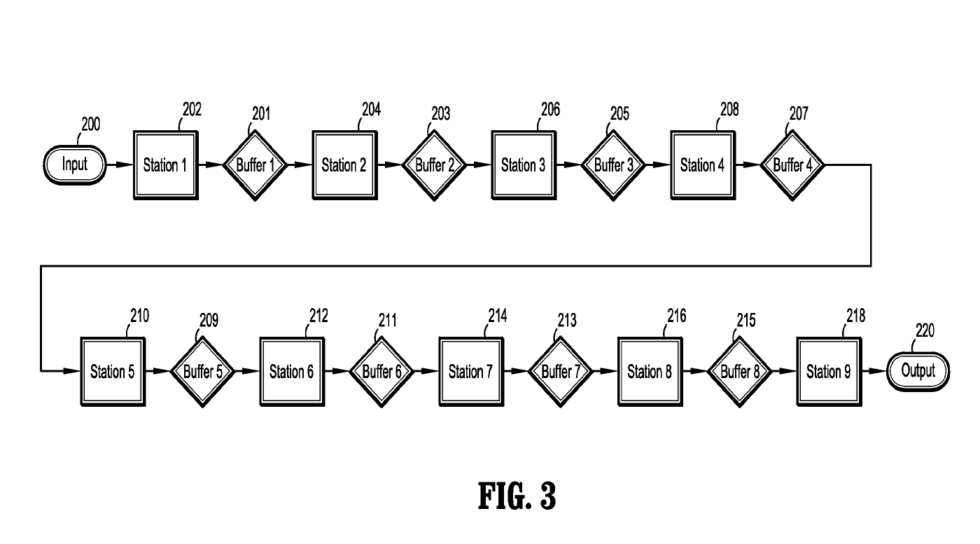

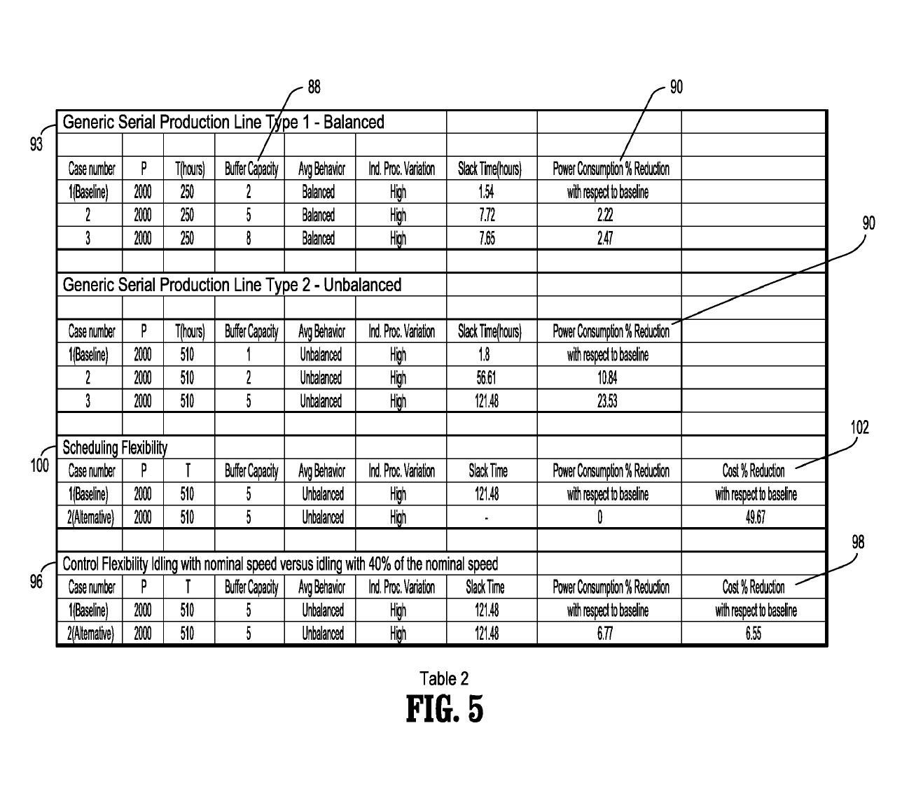

The second case study is for a computer simulation of a generic serial production flow line having a greater process variability than that of the automotive paint shop line. Referring to FIG. 3, a generic serial production flow line is depicted having first 202, second 204, third 206, fourth 208, fifth 210, sixth 212, seventh 214, eighth 216 and ninth 218 stations. First 201, second 203, third 205, fourth 207, fifth 209, sixth 211, seventh 213 and eighth 215 buffers are associated with the first through eighth 202-216 stations, respectively. Results of the computer simulation for a generic serial production flow line 93 are shown in Table 2 of FIG. 5.

The case studies shown in Tables 1 and 2 are run by changing parameter configurations including system state vector X, process variability at individual stations (i.e. Var(θᵢ)), the degree of line balance and others. P and T are set invariant and fixed for all cases studies. Slack times at individual stations and the overall slack time are calculated using the previously described mean value analysis and discrete event simulation. This provides a hybrid approach that enables the generation of case studies where process variability is too high for the mean value analysis to be sufficiently accurate.

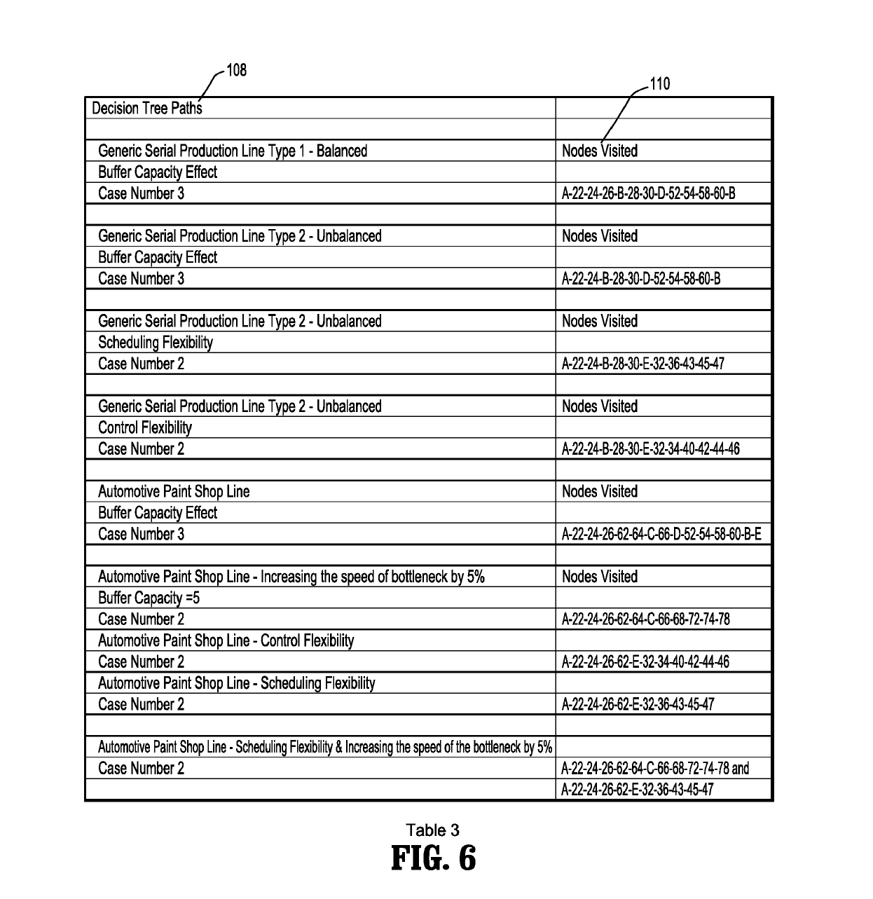

In particular, it can be seen in Tables 1 and 2 that increasing buffer capacity 88 results in a corresponding increase in power consumption reduction 90. In addition, Table 1 shows that increasing the speed of the bottleneck by 5% 92 results in a power consumption % reduction 94. Tables 1 and 2 also show that controlling flexibility idling with nominal speed versus idling with 40% of the nominal speed 96 results in corresponding cost % reductions 98. In addition, Tables 1 and 2 show that scheduling flexibility 100 results in corresponding cost % reductions 102. Further, Table 1 shows that scheduling flexibility and increasing the speed of the bottleneck by 5% 104 results in a corresponding cost % reduction 106. FIG. 6 includes Table 3 which provides the decision tree paths 108 and nodes visited 110 for the automotive paint shop line 91 and the generic serial production flow line 93. It is noted that individual process variation is indicated as “Ind. Proc. Variation” in Tables 1 and 2.

While performing a scheduling flexibility option, consideration should also be given as to whether a system allows shifting of production from the most expensive price to the least expensive price. Such load shifting of production provides the most optimal case but is possible only if the production line has slack time. A probabilistic distribution of the load shifting effect should be formulated and computed when considering this effect. An alternative method to observe the effect of load shifting is through discrete event simulation. In the current invention, the optimal case is considered while calculating a scheduling flexibility option. In particular, while performing load shifting, production which is scheduled at the highest electricity price zone is shifted to the least expensive electricity price zone. The cost difference is given by equation (10).

CostDifference=SlackTime*[ΣElectricityIntensity(Machine(i))*Utilization(Machine(i))]*[Electricity PriceZone(highest)−Electricity PriceZone(lowest)] (10)

Therefore, if a production system already has significant positive slack times and scheduling flexibility is allowed within the constraints of production invariants, the system is then elastic to both energy efficiency and load shifts. Table 1 shows that, depending on the individual process variation, power consumption is reduced and slack time is generated which leads to ELS and EEE opportunities for a production line without impacting the production goals.

It is to be understood that exemplary embodiments of the present disclosure may be implemented in various forms of hardware, software, firmware, special purpose processors, or a combination thereof. In one embodiment, a method for energy management control may be implemented in software as an application program tangibly embodied on a computer readable storage medium or computer program product. As such, the application program is embodied on a non-transitory tangible media. The application program may be uploaded to, and executed by, a processor comprising any suitable architecture.

It should further be understood that any of the methods described herein can include an additional step of providing a system comprising distinct software modules embodied on a computer readable storage medium. The method steps can then be carried out using the distinct software modules and/or sub-modules of the system, as described above, executing on one or more hardware processors. Further, a computer program product can include a computer readable storage medium with code adapted to be implemented to carry out one or more method steps described herein, including the provision of the system with the distinct software modules.

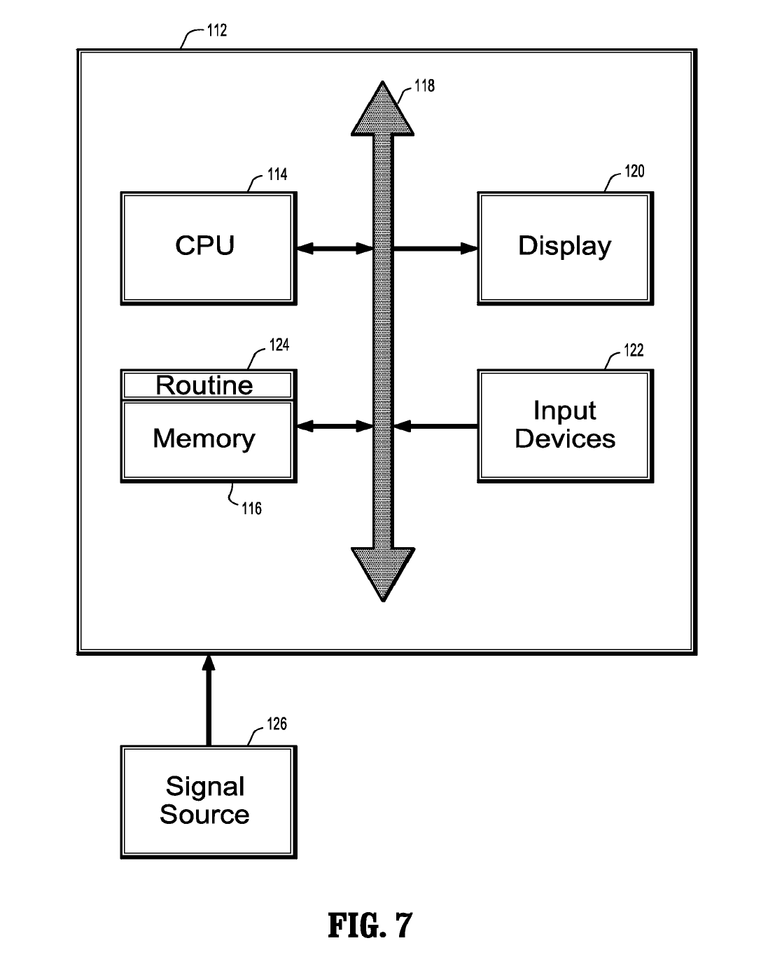

FIG. 7 is a block diagram of a computer system 112 in which embodiments of the above described methods may be implemented. The computer system 112 can comprise, inter alia, a central processing unit (CPU) 114, a memory 116 and an input/output (I/O) interface 118. The computer system 112 is generally coupled through the I/O interface 118 to a display 120 and various input devices 122 such as a mouse, keyboard, touchscreen, camera and others. The support circuits can include circuits such as cache, power supplies, clock circuits, and a communications bus. The memory 116 can include random access memory (RAM), read only memory (ROM), disk drive, tape drive, storage device etc., or a combination thereof. The present invention can be implemented as a routine 124 that is stored in memory 116 and executed by the CPU 114 to process a signal from a signal source 126. As such, the computer system 112 is a general-purpose computer system that becomes a specific purpose computer system when executing the routine 124 of the present invention. The computer system 112 can communicate with one or more networks such as a local area network (LAN), a general wide area network (WAN), and/or a public network (e.g., the Internet) via a network adapter. In addition the computer system 112 may be used as a server as part of a cloud computing system where tasks are performed by remote processing devices that are linked through a communications network. In a distributed cloud computing environment, program modules may be located in both local and remote computer system storage media including memory storage devices.

The computer platform 112 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device. Examples of well-known computing systems, environments, and/or configurations that may be suitable for use with computer system 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices and the like.

Having described exemplary herein, it is noted that modifications and variations can be made by persons skilled in the art in light of the above teachings. It is therefore to be understood that changes may be made in exemplary embodiments of the disclosure, which are within the scope and spirit of the invention as defined by the appended claims. Having thus described the present disclosure with the details and particularity required by the patent laws, what is claimed and desired protected by Letters Patent is set forth in the appended claims.

What is claimed is:

1. A method for energy demand management in a production flow line having a plurality of stations, comprising the steps of:
calculating a slack time for the production flow line or a selected station;
determining an option for operation mode flexibility;
performing a feasibility analysis of the option; and
providing a solution based on an elasticity measure.

2. The method according to claim 1 further including the step of:
determining whether the production line is balanced with respect to average station cycle times.

3. The method according to claim 1 further including the step of:
determining whether there is significant process variability between the stations.

4. The method according to claim 1 wherein operation mode flexibility includes a control flexibility option and a scheduling flexibility option.

5. The method according to claim 4 wherein the control flexibility option includes a shutdown option or a sleep mode option.

6. The method according to claim 4 further including the step of:
performing a feasibility analysis of the scheduling flexibility option.

7. The method according to claim 1 wherein a control option is utilized on a selected station if the slack time for the production flow line is not significantly greater than zero.

8. A method for energy demand management in a balanced production flow line having a plurality of stations wherein at least of the stations is a bottleneck, comprising the steps of:
determining whether there is significant process variability between the stations;
calculating a slack time for the production flow line or a selected station;
determining an option for operation mode flexibility;
performing a feasibility analysis of the option; and
providing a solution based on an elasticity to load shift measure or an elasticity to energy efficiency measure if significant process variability does not exist between the stations, a slack time is not significantly greater than zero and an operation mode flexibility option exists that is economically feasible.

9. The method according to claim 8 wherein the operation mode flexibility option includes speeding up a bottleneck station.

10. The method according to claim 8 wherein operation mode flexibility includes a control flexibility option and a scheduling flexibility option when significant process variability exists between the stations.

11. The method according to claim 10 wherein the control flexibility option includes a shutdown option or a sleep mode option.

12. The method according to claim 10 further including the step of:
performing a feasibility analysis of the scheduling flexibility option.

13. The method according to claim 10 wherein a control option is utilized on a selected station if the slack time for the production flow line is not significantly greater than zero.

14. A method for energy demand management in a production flow line having a plurality of stations, comprising the steps of:
providing production invariants;
determining whether the production line is balanced with respect to average station cycle times;
determining whether there is significant process variability between the stations;
calculating a slack time for the production flow line or a selected station;
determining an option for operation mode flexibility;
performing a feasibility analysis of the option; and
providing a solution based on an elasticity measure.

15. The method according to claim 14 wherein the production invariants include a time interval during which a number of units must be released from the production line.

16. The method according to claim 14 wherein the slack time is calculated by:
Slack_timeᵢ=T−Tᵢ−E(εᵢ)×E(Θᵢ)

17. The method according to claim 14 wherein the slack time is calculated by:
Slack_timeₒᵥₑᵣₐₗₗ( )=T−γ_{b}×( θ̅_{b}+ ω̅_{b}+ η̅_{b})− M̅− B̅

18. The method according to claim 14 wherein operation mode flexibility includes a control flexibility option and a scheduling flexibility option.

19. The method according to claim 18 wherein the control flexibility option includes a shutdown option or a sleep mode option.

20. The method according to claim 18 further including the step of:
performing a feasibility analysis of the scheduling flexibility option.
